(19) United States
(12) Patent Application Publication
(10) Pub. No.: US 2004/0078189 A1
(43) Pub. Date: Apr. 22, 2004

(54) Phonetic identification assisted Chinese input system and method thereof

(76) Inventors: Say-Ling Wen, Taipei (TW); Zechary Chang, Taipei (TW); Leger Wu, Beijing (CN); Back Zhang, Beijing (CN)

Correspondence Address: BIRCH STEWART KOLASCH & BIRCH, PO BOX 747, FALLS CHURCH, VA, 22040-0747, US

(21) Appl. No.: 10/273,294

(22) Filed: Oct. 18, 2002

(51) Int. Cl. G06F 17/28

(52) U.S. Cl. 704/3

(57) ABSTRACT

A Chinese input system and method that utilizes phonetic identification technology for assisting a user in processing selections from candidate sentences and associated categories. Through the phonetic input method, the invention enables a user to select a candidate sentence that s/he wants to input, reducing the input error rate and increasing his/her input speed.

### BACKGROUND OF THE INVENTION

1. Field of the Invention

The invention relates to a Chinese input system and method thereof, and particularly a Chinese input system and method thereof that utilizes phonetic identification technology to assist a user in processing selections of candidate sentences and associated categories to further enable the user to increase his/her input speed.

2. Related Art

The biggest problems of a Chinese input method are slow input speed and inconvenience. Generally, most Chinese input methods that focus on resolving the problem of slow input speed have been developed with the function of disassembling words to achieve the object of increasing a user's input speed. However, before a user can truly increase his/her input speed, s/he has to spend much time self-learning and becoming familiar with one of the disassembly Chinese input methods. It is too difficult and inconvenient to learn to use such a disassembled Chinese input method, and people are not interesting in using it.

Some Chinese input methods attempt to resolve both problems of slow input speed and inconvenience by establishing databases with built-in sentences. This kind of solution enables a user to achieve the objects of speedy input and time saving by directly selecting a sentence from a built-in database without repetitious inputting. However, most of the stored sentences in such a built-in database are listed with probable sentences, one to one, for a user to choose following the user's primary input. The method of choosing a sentence in such a database requires a user to manually input data via a keyboard or mouse, which becomes an obstacle for those users who frequently use the sentence database. Moreover, with this kind of manual Chinese input method users may make mistakes, resulting, in input negligence or carelessness by a user who takes much time and affects the whole input speed.

Current phonetic identification technology has been well developed. Although there are still some technical difficulties, it can still be applied to identify fixed fundamental elements. Therefore, how to develop a Chinese input method with the advantage of phonetic identification technology and how to reduce manual input processes and input error rate to heighten a user's input speed has become a concern for those who use various input-methods.

### SUMMARY OF THE INVENTION

In view of the foregoing, the invention aims at resolving the above-mentioned problems to propose a phonetic identification assisted Chinese input system and method thereof. The main object of the invention is to provide a phonetic-identified Chinese input method to reduce manual input frequency, avoid input mistakes and enhance the input speed of a user by applying phonetic identification technology.

To achieve the aforementioned objects, the invention proposes a phonetic identification assisted Chinese input system and method, which comprises a sentence database, a receiving and identifying module, a data retrieval module, and an output display module.

In addition, the disclosed phonetic identification assisted Chinese input method and system consists of the following Steps: starting an input-method initial interface in an editable file, displaying a categorization checklist, inputting selecting a number regarding the candidate sentence for choosing a item from the categorization, displaying the sentences from the selected categorization, selecting the number regarding the candidate sentence via phonetic input and retrieving a corresponding classified sentence item, and outputting the classified sentence item into the editable file.

The detailed content and technology of the invention is depicted by the following figures and descriptions.

### BRIEF DESCRIPTION OF THE DRAWINGS

FIG. 1 shows a systematic structure of the phonetic identification assisted Chinese input system and method of the invention;

FIG. 2 shows a phonetic input flowchart of according to the invention;

FIG. 3 shows a data retrieval flowchart of the invention; and

FIGS. 4-a, 4-b, and 4-c show the Chinese input method and the phonetic input display of the disclosed system and method, respectively.

### DETAILED DESCRIPTION OF THE INVENTION

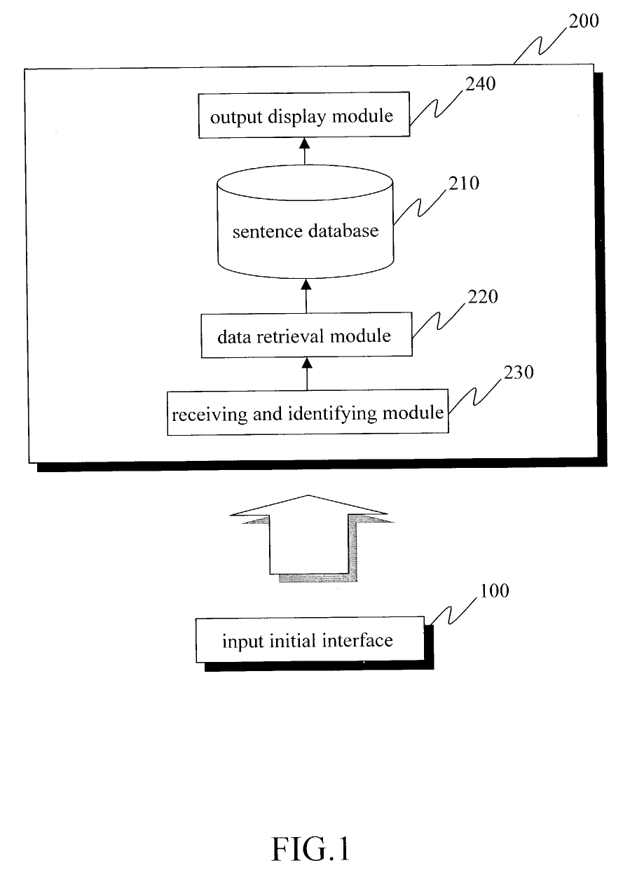

The disclosed invention proposes a phonetic identification assisted Chinese input system and method. The systematic structure of the Chinese input system and method as shown in FIG. 1 is described as follows.

(1) The sentence database 210 is mainly using for storing categorization contents and sentences regarding each categorization. The sentence database 210 is an associated database that establishes associated indexes between each categorization and sentences regarding each categorization to help enhance accuracy and speed in data searching.

(2) The data retrieval module 220 is mainly for retrieving corresponding data content from the sentence database 210 based on transferred phonetic result from a receiving and identifying module 230. The data retrieval module 220 records current displayed categorization checklist status, contrasts transferred phonetic result with existing corresponding data in the database, and retrieves them from the sentence database 210.

(3) The receiving and identifying module 230 mainly carries out identification and transfer tasks of inputted phonetic data by a user via a phonetic input peripheral device. The identification procedure mainly focuses on finding out existing numbers of candidate sentences, which correspond to a user's phonetic input, and verifying if those numbers are within the identifiable range of available candidate sentences. If a user's phonetic input data is beyond the numbering range of candidate sentences or cannot be identified because of his/her unclear voice, the module 230 promptly gives an error message and requests the user to reiterate his/her phonetic data. As for voice transfer, the module transmits analogue signals into digital signals that can be executed by a computer program after it confirms the user's phonetic input is within a reasonable range of identifiable candidate sentence numbers.

(4) The output display module 240 mainly displays a categorization checklist (including a phonetic input area and an item display area). In addition, the output display module 240 automatically outputs a corresponding sentence into an editable file that the user is using, after the user has chosen the sentence regarding the categorization, so that the time of data input by the user is reduced.

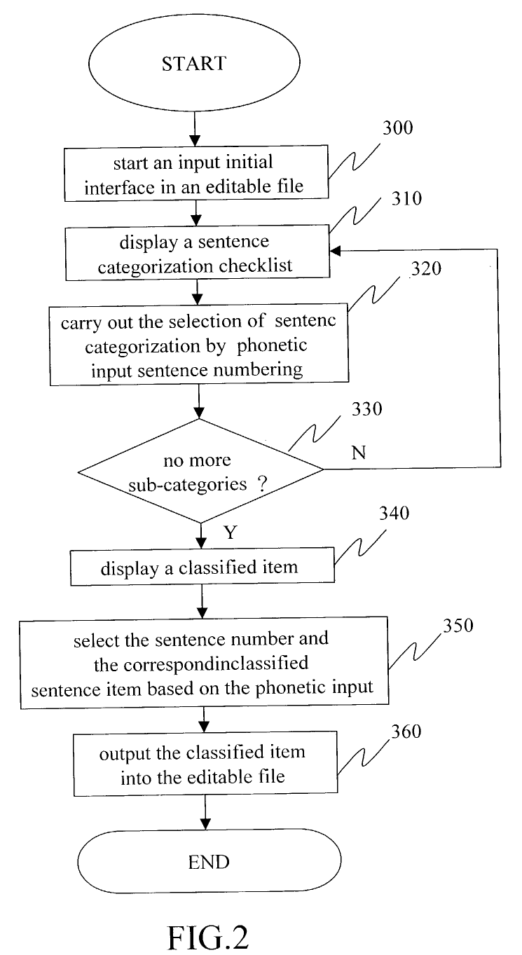

FIG. 2 showing the phonetic input flowchart of the phonetic identification assisted Chinese input system and method describes the main operational flow as follows.

First, a user has to start up an input-method initial interface 100 in an editable file that can be any frequently used software application (such as WORD, Notepad, etc.) (Step 300); the input-method system 200 then shows a display screen with a categorization checklist (Step 310); the display consists of a phonetic input area and an item display area for a user to process phonetic input. The user is able to process categorization selection by utilizing his/her voice for choosing candidate sentence category numbers displayed on the categorization checklist (Step 320). The system then verifies if there are sub-categories under the selected categorization item (Step 330). If YES, the flow goes back to Step 310 and continues displaying more detailed sub-categories; otherwise, it displays sentences regarding the categorization (Step 340). The user is then able to select a required sentence regarding the categorization by entering the number regarding the candidate sentence (Step 350). Finally, the system automatically outputs the selected sentence into the user's editable file (Step 360).

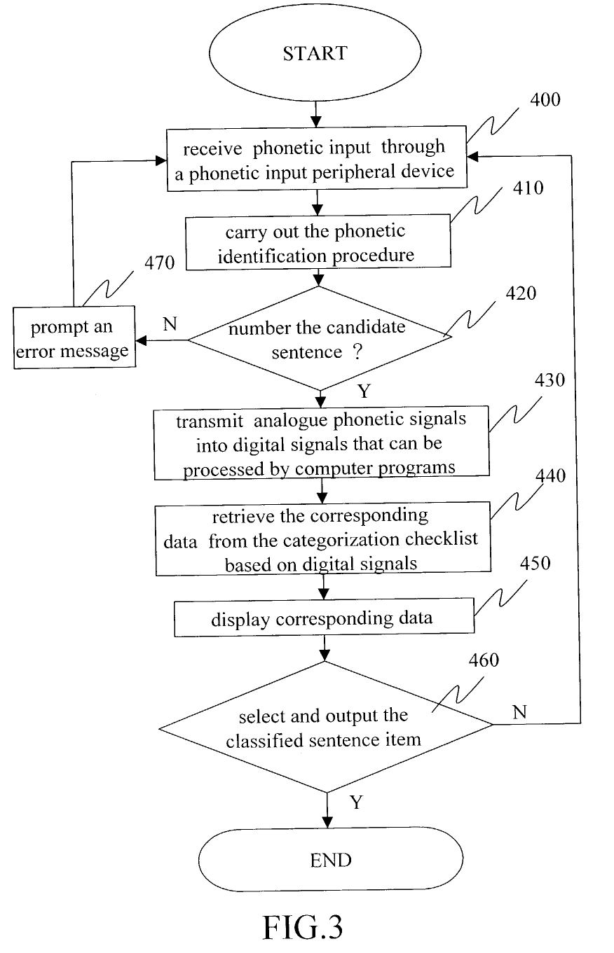

FIG. 3 is a flowchart of data retrieval of the phonetic identification assisted Chinese input system and method.

First, the input system 200 receives phonetic content from the user through a phonetic peripheral device (Step 400), and then carries out the phonetic identification procedure (Step 410). The phonetic identification procedure mainly focuses on finding out if the user's phonetic input data is within the identifiable range of candidate sentences (Step 420). If the user's phonetic data is beyond the numbering range of candidate sentences or cannot be identified, an error message will be promptly given (Step 470). The flow then goes back to Step 400 and the system asks the user to reiterate his/her phonetic input; otherwise, the system continues the process of voice transfer to transmit analogue signals into digital signals (Step 430). The system retrieves data from the categorization checklist that corresponds to those digital signals from the sentence database 210 (Step 440), and displays data through the output display module 240(Step 450). In the meantime, the input system 200 of the invention verifies whether the user has chosen one displayed content and wants to output it while the displayed content has reached the last level of the categorization (Step 460). If NO, there are more sub-categories, so the flow goes back to Step 400 and continues receiving the user's phonetic input; otherwise, the flow is completed.

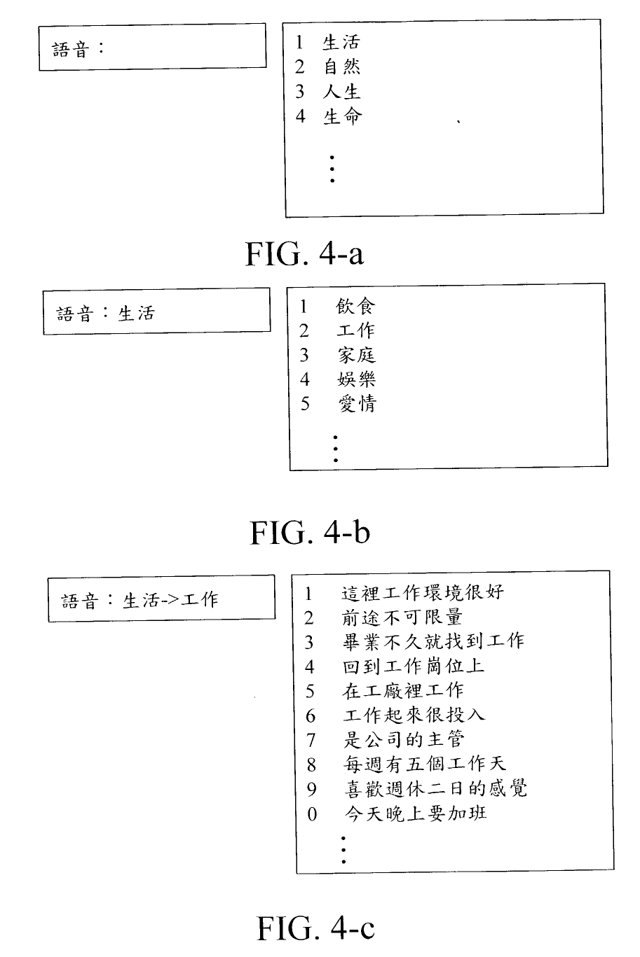

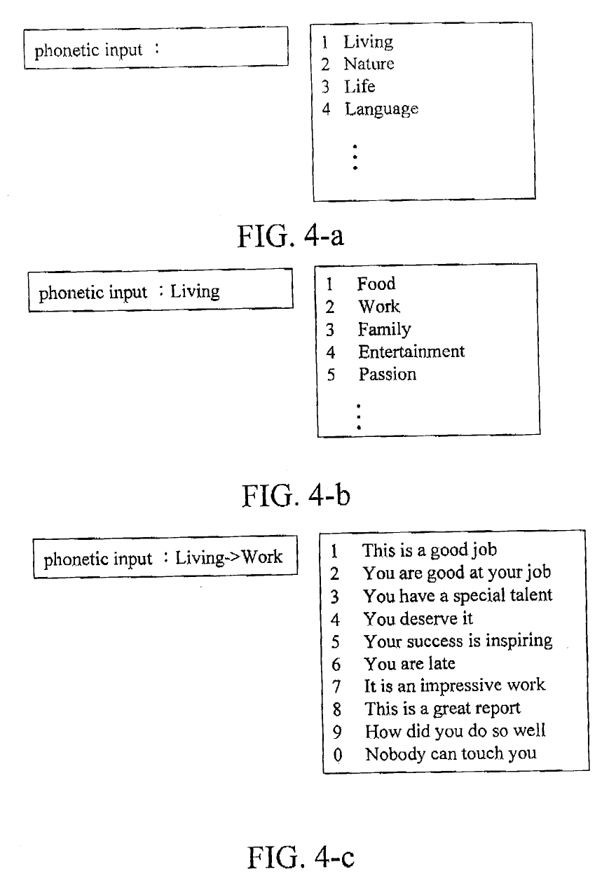

Finally, the preferred embodiment of the invention is further depicted by FIGS. 4-a, 4-b, and 4-c.

The user sees the displayed categorization checklist as shown in FIG. 4-a, in which there are the basic categorizations in the sentence database 210 (e.g. LIVING, NATURE, LIFE, etc.) showing in the item display area for the user to process phonetic input. For instance, if the user wants to input a related sentence under the “LIVING” category, s/he selects a candidate sentence number (i.e. “1”) under the “LIVING” category through his/her phonetic input. As in FIG. 4-b, all sub-categories (including “FOOD & BEVERAGE”, “WORKING”, “FAMILY”, “ENTERTAINMENT”, “PASSION & LOVE”, etc.) under the “LIVING” category are shown in the item display area, where the current categorization status is shown in the phonetic input area. If the user wants to input related sentences under the “WORKING” category, s/he selects a candidate sentence number (i.e. “2”) under the “WORKING” category through phonetic input. Similarly, the system shows all sub-categories under the “WORKING” category. If there are no further sub-categories under the “WORKING” category, the system displays all classified sentences under the category (as shown in FIG. 4-c). The user then is able to select a required sentence number corresponding to the number of the candidate sentence through phonetic input and the system automatically retrieves the corresponding sentence and outputs it into the opened editable file.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A Chinese input system that utilizes phonetic identification technology for assisting a user in proceeding selections from candidate sentences and associated categories to further enable the user to reduce input error rate and heighten his/her input speed, which comprising:
a sentence database for storing categorizations and sentences regarding the categorizations;
a receiving and identifying module for receiving a candidate sentence numbering phonetic voice from a user through a phonetic peripheral device and identify the user's phonetic input and proceed a phonetic transfer;
a data retrieval module for retrieving a corresponding data item from categorization checklist based on the phonetic transfer result; and
an output display module for displaying the categorization checklist and a sentence regarding the categorization and outputting them into an editable file.

2. The system of claim 1, wherein the sentence database is an associated database that provides associated indexes between each of the categorizations and sentences regarding each of the categorization.

3. The system of claim 1, wherein the receiving and identifying module further comprises the function of promptly giving error messages.

4. The system of claim 1, wherein the phonetic transfer is to transmit analogue signals into digital signals that can be processed by computer programs.

5. The system of claim 1, wherein the categorization checklist further comprising of a phonetic input area and an item display area.

6. A Chinese input method that utilizes phonetic identification technology for assisting a user in proceeding key selections from candidate sentences and associated categories to further enable the user to reduce input error rate and heighten his/her input speed, which comprising the steps of:
starting an input-method initial interface in an editable file;
displaying a categorization checklist;
carrying out the selection of the sentence categorization by a phonetic inputted sentence numbering;
displaying sentences regarding the selected categorization;
selecting the candidate sentence number and the corresponding sentence regarding the selected categorization based on the phonetic input; and
outputting the selected sentence regarding the selected categorization into the editable file.

7. The method of claim 6, wherein the categorization checklist further comprises of a phonetic input area and an item display area.

8. The method of claim 6, wherein the Step of carrying out the selection of the sentence categorization by a phonetic inputted sentence numbering and selecting the sentence number and the Step of selecting the candidate sentence number and the corresponding sentence regarding the selected categorization based on the phonetic input further comprise of the following Steps:
receiving a phonetic voice through a phonetic input peripheral device;
carrying out the phonetic identification procedure;
transmitting analogue phonetic signals into digital signals that can be processed by computer programs; and
displaying corresponding data item.

9. The method of claim 8, wherein the receiving and identifying module further comprises the function of promptly giving error messages.
